(19) United States
(12) Patent Application Publication
(10) Pub. No.: US 2025/0386204 A1
(43) Pub. Date: Dec. 18, 2025

(54) CONTROLLED LTE CRS MUTING FOR SPECTRUM SHARING

(71) Applicant: Telefonaktiebolaget LM Ericsson (publ), Stockholm (SE)

(72) Inventor: Hong REN, Kanata, Ontario (CA)

(73) Assignee: Telefonaktiebolaget LM Ericsson (publ), Stockholm (SE)

(21) Appl. No.: 18/878,066

(22) PCT Filed: Jul. 14, 2022
(86) PCT No.: PCT/IB2022/056515

§ 371 Date: Dec. 22, 2024

(51) Int. Cl. H04W 16/14; H04L 1/00; H04L 5/00

(52) U.S. Cl. CPC H04W 16/14; H04L 1/0003; H04L 1/0068; H04L 5/0051

(57) ABSTRACT

Systems and method for controlled Long Term Evolution (LTE) Cell-specific Reference Signal (CRS) muting for Dynamic Spectrum Sharing (DSS) are disclosed herein. In some embodiments, a method performed by a radio access node for a DSS system serving LTE and New Radio (NR) comprises (a) determining a maximum number of CRS-muted Physical Resource Blocks (PRBs), (b) determining, based on the determined maximum number of CRS-muted PRBs, an LTE CRS rate matching pattern set for the one or more NR cells, the LTE CRS rate matching pattern set containing one or more LTE CRS rate matching patterns, (c) selecting an LTE CRS rate matching pattern from the determined LTE CRS rate matching pattern set for a User Equipment (UE), and (d) sending information that is indicative of the selected LTE CRS rate matching pattern to the UE.

### TECHNICAL FIELD

The present disclosure is directed to controlled Long Term Evolution (LTE) Cell-specific Reference Signal (CRS) muting for Dynamic Spectrum Sharing (DSS).

### BACKGROUND

### Long Term Evolution (LTE)/New Radio (NR) Spectrum Sharing

Wireless operators around the world have already started to deploy the latest wireless technology—NR. When NR penetration is low at the beginning of deployment, allocating a dedicated spectrum to NR can be a waste of radio resources when NR cannot fully utilize the spectrum. Spectrum sharing provides the capability to allow NR and LTE to share the same spectrum. Spectrum sharing enables operators to introduce NR while serving LTE users in the same spectrum.

FIG. 1 illustrates one example of spectrum sharing. In the illustrated example, a radio access node includes a Dynamic Spectrum Sharing (DSS) controller 100, which may be a general microprocessor and its related software that perform functions related to spectrum sharing for LTE and NR. The radio access node may further include an LTE scheduler 101 and an LTE physical layer processor 102 for LTE data transmissions and a NR scheduler 103 and NR physical layer processor 104 for NR data transmissions, as shown in FIG. 1. As illustrated, the DSS controller 100 works together with the LTE side and NR side to allow both NR data transmissions and LTE data transmissions in the same frequency spectrum. For example, radio resources are dynamically allocated to NR data transmissions and LTE data transmissions, e.g., in each 1 millisecond (ms) subframe.

NR PDSCH Physical Downlink Shared Channel (PDSCH) Rate Matching around LTE Cell-specific Reference Signal (CRS)

CRS is the most basic reference signal in LTE downlink (DL). In order for NR transmissions not to affect existing LTE transmissions, the LTE CRS should be avoided when allocating resources for NR transmissions. Rate matching in PDSCH is a baseband processing function where the number of bits in a transport block is matched to the number of bits that can be transmitted in the given resource, as disclosed in 3^{rd} Generation Partnership Project (3GPP) Technical Specification (TS) 38.212, “Multiplexing and channel coding,” version 17.1.0, 2022-04-01. Rate matching enables data transmission of NR (i.e., NR PDSCH) to be allocated only to time-frequency resources where LTE CRS is not located. CRS-related information, such as the number of CRS ports, CRS location, and LTE bandwidth is signaled to NR User Equipments (UEs) for CRS rate matching via Radio Resource Control (RRC) configuration, as disclosed in 3GPP TS 38.331, “Radio Resource Control (RRC) protocol specification,” version 17.0.0, 2022 Apr. 19.

In other words, LTE CRS is an always-on signal. It is transmitted in every Physical Resource Block (PRB) and in every subframe. With spectrum sharing, when NR PDSCH is transmitted on certain PRBs, the Resource Elements (REs) used for LTE CRS cannot be used for NR PDSCH. NR PDSCH has to rate match around the REs used for LTE CRS. This is achieved by configuring the LTE CRS rate matching pattern for NR UEs. The LTE CRS rate matching pattern is specified by several parameters including the LTE DL center frequency and the LTE bandwidth. Once an LTE CRS rate matching pattern is configured for a NR UE (e.g., the LTE CRS rate matching pattern is transmitted to the NR UE), the NR UE assumes the CRS is transmitted in every subframe within the configured bandwidth when performing the rate matching.

### Resource Arbitration

For spectrum sharing, the PRBs in the same spectrum are shared between LTE and NR. The PRBs can be divided based on estimated demand from LTE and NR, and this is referred to as to “resource arbitration.” The estimated demand can be expressed as the number of required PRBs. Resource arbitration can be performed before scheduling, for example, by the DSS controller 100. Then, the LTE physical layer processor 102 and the NR scheduler 103 can perform scheduling independently with the PRBs assigned by resource arbitration.

Resource arbitration can be done in the frequency domain in every subframe. It can also be performed in both time and frequency domains. For example, NR may be given a higher priority in one subframe. That is, the subframe may be assigned to NR only if NR has enough demand. Similarly, LTE can be given a higher priority in the next subframe so the subframe may be assigned to LTE if LTE has enough demand. When the Radio Access Technology (RAT) with higher priority does not have enough demand to utilize all PRBs in a subframe, the remaining PRBs can be assigned to the other RAT.

### SUMMARY

Embodiments of controlled Long Term Evolution (LTE) Cell-specific Reference Signal (CRS) muting for Dynamic Spectrum Sharing (DSS) are disclosed herein. In one embodiment, a method performed by a radio access node for a DSS system serving at least two Radio Access Technologies, LTE and New Radio (NR) comprises determining a maximum number of CRS-muted Physical Resource Blocks (PRBs) over which an LTE CRS is muted in a bandwidth of one or more LTE cells for which DSS between the one or more LTE cells and one or more NR cells is being performed. The method also comprises determining, based on the determined maximum number of CRS-muted PRBs, an LTE CRS rate matching pattern set for the one or more NR cells, the LTE CRS rate matching pattern set containing one or more LTE CRS rate matching patterns. The method further comprises selecting an LTE CRS rate matching pattern from the determined LTE CRS rate matching pattern set for a User Equipment (UE), and sending information that is indicative of the selected LTE CRS rate matching pattern to the UE. By this way, NR spectral efficiency is improved.

In one embodiment, the method further comprises setting a CRS muting forbidden region as (a) 6 PRBs in the middle of the bandwidth or (b) a number of PRBs in the middle of the bandwidth, which depend on the determined maximum number of CRS-muted PRBs and the determined LTE CRS rate matching pattern set.

In one embodiment, the maximum number of CRS-muted PRBs corresponds to any number of PRBs not greater than the bandwidth of the LTE cell for which DSS is being performed, or a limited number of values that are not greater than the LTE bandwidth.

In one embodiment, the LTE CRS rate matching pattern set comprises two LTE CRS rate matching patterns having (a) a common LTE downlink center frequency and (b) two different bandwidths.

In one embodiment, the LTE CRS rate matching pattern set comprises (i) a first LTE CRS rate matching pattern having (a) a first LTE downlink center frequency and (b) a first bandwidth, (ii) a second LTE CRS rate matching pattern having (a) a second LTE downlink center frequency that is lower than the first LTE downlink center frequency and (b) a second bandwidth, which is the same as or different from the first bandwidth, (iii) a third LTE CRS rate matching pattern having (a) a third LTE downlink center frequency that is higher than the first LTE downlink center frequency and (b) a third bandwidth, which is equal to the second bandwidth.

In one embodiment, wherein the LTE CRS rate matching patterns comprises (a) a first LTE CRS rate matching pattern having a center frequency shifted upwards from a true center frequency of the bandwidth of one or more LTE cells for which DSS is being performed and (b) a second LTE CRS rate matching pattern having a center frequency shifted downwards from the true center frequency of the bandwidth of the one or more LTE cells for which DSS is being performed.

In one embodiment, the radio access node comprises a DSS controller, an LTE scheduler and an LTE physical layer processor for LTE data, and a NR scheduler and an NR physical layer processor for NR data.

In one embodiment, the DSS controller determines PRBs assigned to LTE and NR, determines an LTE CRS muting period and identifies PRBs that are eligible for LTE CRS muting, determines PRBs for LTE CRS muting as up to the determined maximum number of CRS-muted PRBs from an intersection of eligible PRBs and PRBs assigned to NR, sends, to the LTE physical layer processor and the NR scheduler, information that is indicative of the PRBs for LTE CRS muting, and updates a time stamp for the PRBs over which LTE CRS is to be muted.

In one embodiment, the LTE physical layer processor performs CRS muting based on the determined PRBs for CRS muting.

In one embodiment, the NR scheduler selects PRBs for a UE based on the CRS-muted PRBs and the LTE CRS rate matching pattern configured for the UE.

In one embodiment, the NR scheduler selects downlink Modulation and Coding Scheme (MCS) for the UE based on its downlink link quality, the PRBs allocated to the UE and the number of PRBs over which NR PDSCH will be punctured by LTE CRS among the PRBs allocated for the UE.

Corresponding embodiments of the radio access node are also disclosed herein.

In one embodiment, the radio access node for a DSS system serving at least two Radio Access Technologies, LTE and NR, is adapted to (a) determine a maximum number of CRS-muted PRBs over which an LTE CRS is muted in a bandwidth of one or more LTE cells for which DSS between the one or more LTE cells and one or more NR cells is being performed, (b) determine, based on the determined maximum number of CRS-muted PRBs, an LTE CRS rate matching pattern set for the one or more NR cells, the LTE CRS rate matching pattern set containing one or more LTE CRS rate matching patterns, (c) select an LTE CRS rate matching pattern from the determined LTE CRS rate matching pattern set for a UE, and (d) send information that is indicative of the selected LTE CRS rate matching pattern to the UE.

In one embodiment, the radio access node for a DSS system serving at least two Radio Access Technologies, LTE and NR, comprises processing circuitry configured to cause the radio access node to (a) determine a maximum number of CRS-muted PRBs over which an LTE CRS is muted in a bandwidth of one or more LTE cells for which DSS between the one or more LTE cells and one or more NR cells is being performed, (b) determine, based on the determined maximum number of CRS-muted PRBs, an LTE CRS rate matching pattern set for the one or more NR cells, the LTE CRS rate matching pattern set containing one or more LTE CRS rate matching patterns, (c) select an LTE CRS rate matching pattern from the determined LTE CRS rate matching pattern set for a UE, and (d) send information that is indicative of the selected LTE CRS rate matching pattern to the UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of Dynamic Spectrum Sharing (DSS) system for Long Term Evolution (LTE) and New Radio (NR).

FIG. 2 illustrates one example of a cellular communications system according to some embodiments of the present disclosure.

FIG. 3 illustrates examples of LTE rate matching pattern sets each having one Cell-specific Reference Signal (CRS) rate matching pattern.

FIG. 4 illustrates examples of LTE rate matching pattern sets each having two CRS rate matching patterns.

FIG. 5 illustrates examples of LTE rate matching pattern sets each having three CRS rate matching patterns.

FIG. 6 illustrates three LTE CRS rate matching patterns in an LTE CRS rate matching pattern set when a maximum number of muted PRBs is 25 in 10 MHz bandwidth of LTE.

FIG. 7 illustrates three LTE CRS rate matching patterns in an LTE CRS rate matching pattern set when a maximum number of muted PRBs is 15 in 10 MHz bandwidth of LTE.

FIG. 8 illustrates three LTE CRS rate matching patterns in an LTE CRS rate matching pattern set when a maximum number of muted PRBs is 35 in 15 MHz bandwidth of LTE.

FIG. 9 illustrates one example of NR Physical Downlink Shared Channel (PDSCH) link adaptation.

FIG. 10 illustrates another example of NR PDSCH link adaptation.

FIG. 11 is a flow chart of an exemplary embodiment of cell configuration and LTE CRS rate matching pattern selection in the present disclosure.

FIG. 12 is a flow chart of an exemplary embodiment of a DSS controller interacting with an LTE physical layer processor and a NR scheduler in the present disclosure.

FIG. 13 is a schematic block diagram of a radio access node according to some embodiments of the present disclosure.

FIG. 14 is a schematic block diagram that illustrates a virtualized embodiment of the radio access node of FIG. 13 according to some embodiments of the present disclosure.

FIG. 15 is a schematic block diagram of the radio access node of FIG. 13 according to some other embodiments of the present disclosure.

FIG. 16 is a schematic block diagram of a User Equipment (UE) device according to some embodiments of the present disclosure.

FIG. 17 is a schematic block diagram of the UE of FIG. 16 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell;” however, particularly with respect to 5G NR concepts, beams may be used instead of cells and, as such, it is important to note that the concepts described herein are equally applicable to both cells and beams.

As described earlier, when using Dynamic Spectrum Sharing (DSS) for LTE and NR, NR Physical Downlink Shared Channel (PDSCH) has to rate match around LTE Cell-specific Reference Signal (CRS) in every subframe. In other words, LTE CRS creates an overhead for NR PDSCH. This reduces the number of REs used by NR PDSCH and thus NR spectral efficiency (i.e., the number of information bits that can be carried per hertz (Hz) or per Physical Resource Block (PRB)).

It is possible to improve NR spectral efficiency if we can sometimes mute LTE CRS on some PRBs in some subframes and direct NR UEs not to perform rate matching around LTE CRS on those PRBs when LTE CRS is muted. Please note that LTE CRS is muted only on some PRBs in some subframes in order to minimize performance impacts on LTE. This requires NR UEs to perform rate matching around LTE CRS dynamically, which is not allowed by 3GPP specifications.

Embodiments of the present disclosure provide a comprehensive solution to the aforementioned and/or other problems. Embodiments of the present disclosure allow NR UEs to take the advantage of LTE CRS muting without dynamic rate matching. Embodiments of the present disclosure also allow operators to balance between NR spectral efficiency improvement and LTE performance degradation. Embodiments of the present disclosure may provide many options from which the operators can choose to configure their networks when using DSS with LTE CRS muting. In one embodiment, the LTE CRS muting is controlled based on: (a) a maximum number of PRBs over which CRS is muted in a subframe, (b) a muting period, (c) LTE CRS rate matching pattern “set,” and/or (d) CRS muting forbidden region (PRBs over which CRS muting is not allowed). With the above controlled LTE CRS muting, a desired tradeoff between improving NR performance and degrading LTE performance can be achieved.

Embodiments of the present disclosure aim to improve NR performance by muting LTE CRS in a controlled manner. Embodiments of the present disclosure may include any one or more of the following features: (a) flexibility to set the limit for the maximum number of PRBs over which CRS is muted, (b) a method to generate multiple LTE CRS rate matching pattern sets when the maximum number of PRBs over which CRS is muted is determined, (c) a method to select one LTE CRS rate matching pattern set for a DSS cell, (d) a method for a network node (e.g., a gNB) to select one pattern among the LTE CRS rate matching patterns in a set for a UE, and (e) flexibility to set a muting period.

Embodiments of the present disclosure may provide any one or more of the following advantages over the existing solution: (a) controlled CRS muting to balance NR and LTE performance, (b) improved NR performance, and (c) better LTE performance with less improvement on NR.

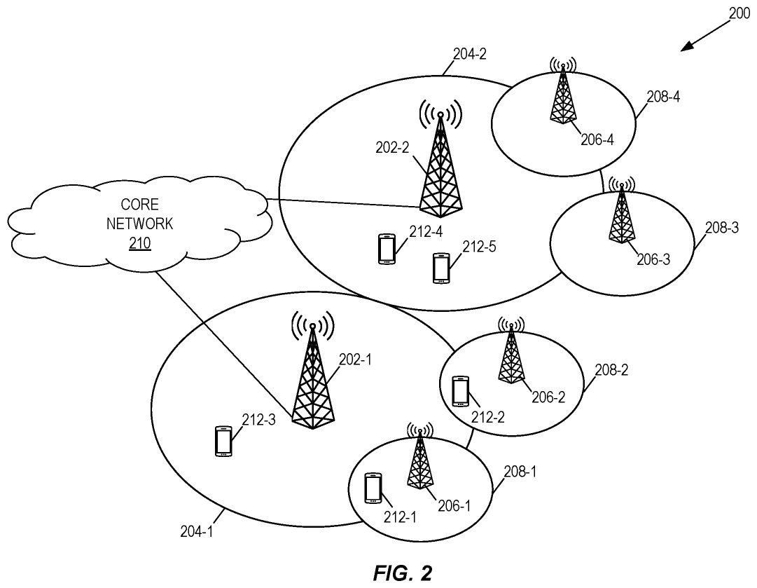

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 202-1 and 202-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5GS is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

In relation to embodiments of the present disclosure, at least one of the cells 204 and/or 208 is a DSS cell (i.e., the frequency spectrum of the cell is shared by two (or more) RATs, which in the example embodiments described herein are LTE and NR).

Now, the description will focus on embodiments of the present disclosure in which LTE CRS muting is controlled based on one or more of the following factors:
A. Maximum Number of Muted PRBs: The maximum number of PRBs over which LTE CRS is muted in a subframe can be limited. The purpose of the limit is to control the impact on LTE.
B. LTE CRS Muting Period: The muting period is used to control how often CRS on the same PRB can be muted. Specifically, CRS on the same PRB should not be muted more than once in a muting period.
C. LTE CRS Muting Forbidden Region: The LTE CRS muting forbidden region is a set of PRBs over which LTE CRS muting is not allowed. In some embodiments, this region is fixed (e.g., the middle 6 PRBs). In some other embodiments, this region depends on the selected maximum number of muted PRBs and/or the selected LTE CRS rate matching pattern set.
D. LTE CRS rate matching patterns.

An LTE CRS rate matching pattern is determined by many parameters. More specifically, for DSS, a frequency spectrum is shared by an LTE cell and an NR cell. When using DSS, the combination of the LTE cell and NR cell is sometimes referred to as a DSS cell. The LTE CRS rate matching pattern is determined by many parameters including the LTE downlink (DL) center frequency (“a true center frequency”) for the LTE cell for which DSS is performed for the LTE cell and an LTE bandwidth of the LTE cell for which DSS is performed. Note that while the example embodiments disclosed herein focus on DSS between a single LTE cell and a single NR cell, DSS may be performed in accordance with embodiments of the present disclosure for one or more LTE cells and one or more NR cells.

In some embodiments, an LTE CRS rate matching pattern set may contain one LTE CRS rate matching pattern or multiple LTE CRS rate matching patterns, as described in the examples below.

Example 1: As a first example, each LTE CRS rate matching pattern set contains only one pattern. As one specific example, the available LTE CRS rate matching pattern sets include:
Set 1: one pattern with the true center frequency and a bandwidth of 6 PRBs, or
Set 2: one pattern with the true center frequency and a bandwidth of 15 PRBs.

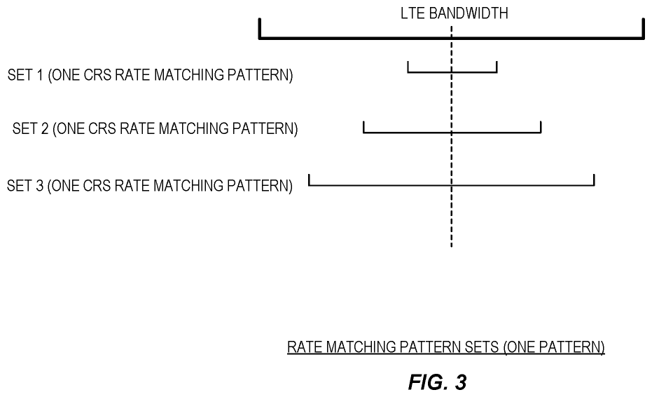

FIG. 3 illustrates examples of LTE CRS rate matching pattern sets, each comprising only one pattern.

Example 2: As a second example, each LTE CRS rate matching pattern set contains two LTE CRS rate matching patterns. As one specific example, the available LTE CRS rate matching pattern sets include:
Set 1:
   Pattern 1: the true center frequency and a bandwidth of 6 PRBs.
   Pattern 2: the true center frequency and a bandwidth of 15 PRBs.
Set 2:
   Pattern 1: the true center frequency and a bandwidth of 6 PRBs.
   Pattern 2: the true center frequency and a bandwidth of 25 PRBs.
Set 3:
   Pattern 1: the true center frequency and a bandwidth of 15 PRBs.
   Pattern 2: the true center frequency and a bandwidth of 25 PRBs.

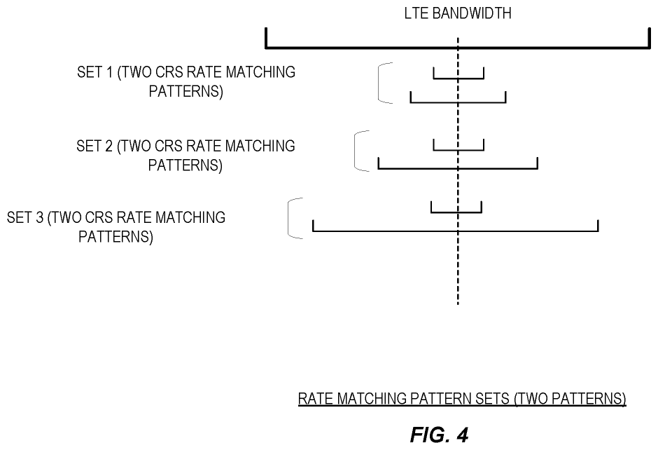

FIG. 4 illustrates examples of LTE CRS rate matching pattern sets, each comprising two patterns.

Example 3: As a third example, each LTE CRS rate matching pattern set contains three LTE CRS rate matching patterns. As one specific example, the available LTE CRS rate matching pattern sets include:
Set 1:
   Pattern 1: the true center frequency and a bandwidth of 6 PRBs.
   Pattern 2: the bandwidth for the rate matching pattern is 15 PRBs. The center frequency for the rate matching pattern is shifted towards lower spectrum.
   Pattern 3: the bandwidth for the rate matching pattern is 15 PRBs. The center frequency for the rate matching pattern is shifted towards upper spectrum.
Set 2:
   Pattern 1: the true center frequency and a bandwidth of 15 PRBs.
   Pattern 2: the bandwidth for the rate matching pattern is 25 PRBs. The center frequency for the rate matching pattern is shifted towards lower spectrum.
   Pattern 3: the bandwidth for the rate matching pattern is 25 PRBs. The center frequency for the rate matching pattern is shifted towards upper spectrum.

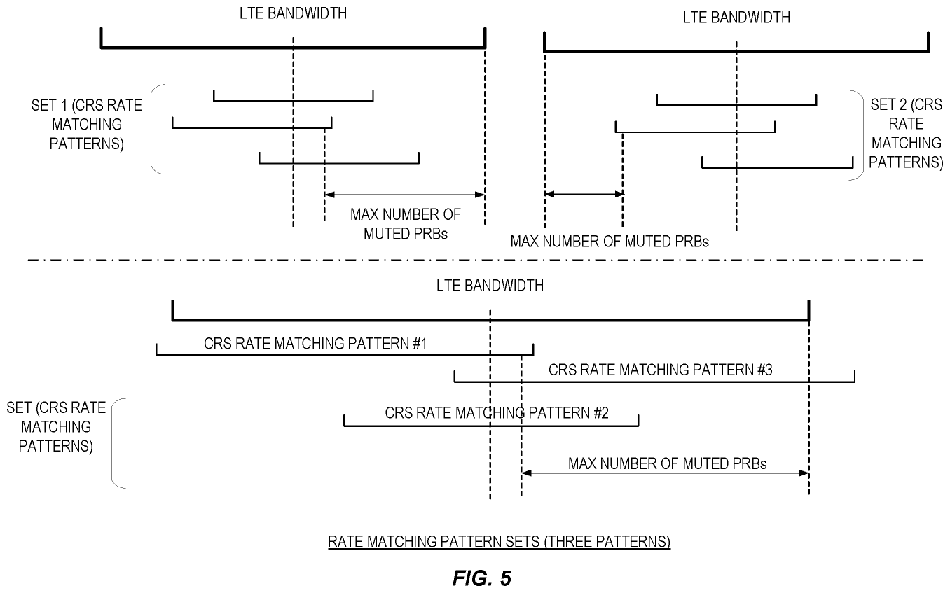

FIG. 5 illustrates examples of LTE CRS rate matching pattern sets, each comprising three patterns.

In some embodiments, for a given bandwidth and the selected (e.g., configured) maximum number of muted PRBs, only a limited number of CRS rate matching pattern sets may be considered. In one example embodiment, first, if the maximum number of muted PRBs is close to the true LTE bandwidth, only one-pattern sets may be considered. If aggressive CRS muting is preferred, the LTE CRS rate matching pattern set may contain the pattern with true center frequency with a bandwidth of 6 PRBs. The CRS muting forbidden region is the middle 6 PRBs. If less aggressive CRS muting is wanted, the LTE CRS rate matching pattern set may contain the pattern with true center frequency with a bandwidth of 15 PRBs. The CRS muting forbidden region is the middle 6 or 15 PRBs.

Second, else if the maximum number of muted PRBs is equal to or larger than half of the true LTE bandwidth,
If there is a rate matching pattern bandwidth (W) that satisfies the condition “maximum number of muted PRBs”+W is close to the true LTE bandwidth, the set may contain the pattern with the true center frequency with a bandwidth of W.
If there are two rate matching pattern bandwidths (W1 and W2, with W1<W2) so that {(maximum number of muted PRBs)+W1<true LTE bandwidth} and {(maximum number of muted PRBs)+W2>true LTE bandwidth}, three sets may be considered:
   Set 1: one pattern with the true center frequency with a bandwidth of W1.
   Set 2: one pattern with the true center frequency with a bandwidth of W2.
   Set 3:2-patterns set.
      Pattern 1: with the true center frequency with a bandwidth of W1.
      Pattern 2: with the true center frequency with a bandwidth of W2.
One or multiple 3-pattern set(s) may also be considered.
   Set 4: 3-patterns set
      Pattern 1: the true center frequency with a bandwidth of W1.
      Pattern 2: the bandwidth for the rate matching pattern is W2. The center frequency shift is determined based on the configured maximum number of muted PRBs.
      Pattern 3: the bandwidth for the rate matching pattern is W2. The center frequency shift is determined based on the configured maximum number of muted PRBs.

Third, in other cases,
Multiple 3-pattern sets are considered. The multiple 3-pattern sets may have different W1 or W2. For example, Set 1 of the multiple 3-pattern sets is:
   Set 1
      Pattern 1: the true center frequency with a bandwidth of W1.
      Pattern 2: the bandwidth for the rate matching pattern is W2. The center frequency shift is determined based on the configured maximum number of muted.
      Pattern 3: the bandwidth for the rate matching pattern is W2. The center frequency shift is determined based on the configured maximum number of muted PRBs.

When multiple LTE CRS rate matching pattern sets are available for the configured maximum number of muted PRBs and the given bandwidth, one LTE CRS rate matching pattern set can be selected for a DSS cell.

### LTE Rate Matching Pattern Set Selection

In one embodiment, the maximum number of muted PRBs is limited to a predefined or configured set of PRB values. This set of PRB values is also referred to herein as a set of maximum number of muted PRB values. In one embodiment, LTE CRS rate matching pattern sets that are supported are determined for each value in the set of maximum number of muted PRB values.

First Example with 10 MHz LTE Bandwidth: A first example for a 10 MHz LTE bandwidth is described below. In LTE, a 10 MHz bandwidth includes 50 useable PRBs. In this example, the set of maximum number of muted PRB values that are supported are: 50 PRBs, 35 PRBs, 25 PRBs, and 15 PRBs. Note, however, that these values are only examples.

In this first example, with the maximum number of muted PRBs=50, there is only one LTE CRS rate matching pattern set with one pattern: the true center frequency with a bandwidth of 6 PRBs. The CRS muting forbidden region is the middle 6 PRBs.

In this first example, with the maximum number of muted PRBs=35, there is only one rate matching pattern set with one pattern: the true center frequency with a bandwidth of 15 PRBs. Given the bandwidth is an odd number, the rate matching pattern can only fully cover the middle 14 PRBs. It partially covers 2 PRBs next to the middle 14 PRBs. The CRS muting forbidden region can be the middle 6. It can also be the middle 14 or 16 PRBs.

In this first example, with the maximum number of muted PRBs=25, there are two rate matching pattern sets as follows:
Set 1 with one pattern: the true center frequency with a bandwidth of 25 PRBs. The CRS muting forbidden region can be the middle 6. It can also be the middle 24 or 26 PRBs.
Set 2 with three patterns:
   Pattern 1: the true center frequency with a bandwidth of 25 PRBs.
   Pattern 2: a bandwidth of 25 PRBs, a center frequency shifted upwards by about 10 PRBs.
   Pattern 3: a bandwidth of 25 PRBs, a center frequency shifted downwards by about 10 PRBs

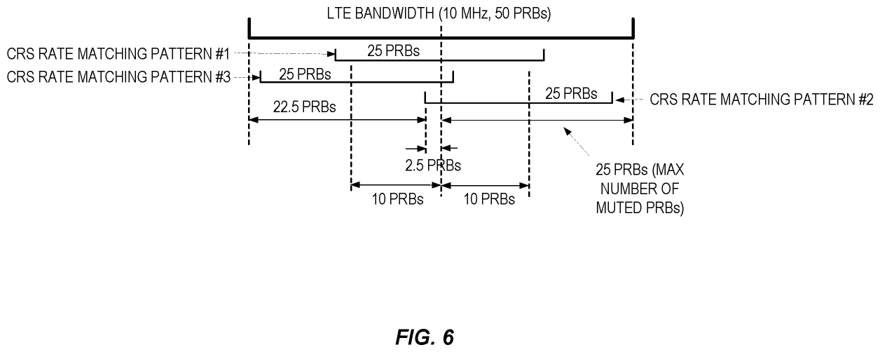

FIG. 6 illustrates the above three patterns for Set 2 for the first example with the maximum number of muted PRBs=25. The CRS muting forbidden region can be the middle 6 PRBs.

The following should be considered when determining the amount of center frequency shift for different LTE CRS rate matching patterns in a set (e.g., when determining the amount of center frequency shift for the different LTE CRS patterns in Set 2 for the first example above with the maximum number of muted PRBs=25). The LTE center frequency has to be a multiple of 100 kHz. This means the frequency shift needs to be a multiple of 100 kHz. Given the sub-carrier spacing is 15 kHz, 5 PRBs is 900 kHz (=15 kHz×12×5) and is a valid frequency shift.

When the center frequency of a LTE CRS rate matching pattern is shifted upwards, one possible motivation is to move the rate matching pattern so that it is away from the lower edge of the bandwidth by about the maximum number of muted PRBs. At the same time, it is preferred that the lower end of the rate matching pattern is at least 3 PRBs below the true center frequency. Looking at the pattern 2 above, without shifting the center frequency of the rate matching pattern, the pattern is 12.5 PRBs away from the lower edge of the bandwidth. To make the rate matching pattern about 25 PRBs away from the lower edge of the bandwidth, the center frequency should be shifted by about 12.5 PRBs. Since the frequency shift has to be multiple of 5 PRBs and it is preferred that the lower end of the rate matching pattern is at least 3 PRBs below the true center frequency, the frequency shift is determined to be 10 PRBs.

When the center frequency of a rate matching pattern is shifted upwards, the other possible motivation is to move the rate matching pattern so that it is away from the upper edge of the bandwidth by about the maximum number of muted PRBs. At the same time, it is preferred that the lower end of the rate matching pattern is at least 3 PRBs below the true center frequency.

When the center frequency of a rate matching pattern is shifted downwards, one possible motivation is to move the rate matching pattern so that it is away from the upper edge of the bandwidth by about the maximum number of muted PRBs. At the same time, it is preferred that the upper end of the rate matching pattern is at least 3 PRBs above the true center frequency. Look at the pattern 3 above, without shifting the center frequency of the rate matching pattern, the pattern is 12.5 PRBs away from the upper edge of the bandwidth. To make the rate matching pattern about 25 PRBs away from the upper edge of the bandwidth, the center frequency should be shifted by about 12.5 PRBs. Since the frequency shift has to be multiple of 5 PRBs and it is preferred that the upper end of the rate matching pattern is at least 3 PRBs above the true center frequency, the frequency shift is determined to be 10 PRBs.

When the center frequency of a rate matching pattern is shifted downwards, the other possible motivation is to move the rate matching pattern so that it is away from the lower edge of the bandwidth by about the maximum number of muted PRBs. At the same time, it is preferred that the upper end of the rate matching pattern is at least 3 PRBs above the true center frequency.

In this first example, with a maximum number of muted PRBs=15, there is only one rate matching pattern set with three patterns:
Pattern 1: the true center frequency with a bandwidth of 25 PRBs.
Pattern 2: a bandwidth of 50 PRBs, the center frequency shifted upwards by about 15 PRBs
Pattern 3: a bandwidth of 50 PRBs, the center frequency shifted downwards by about 15 PRBs

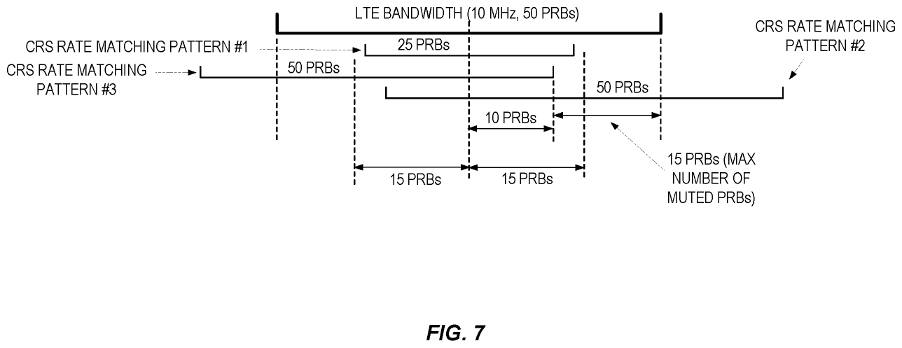

FIG. 7 illustrates the above three patterns for the first example with the maximum number of muted PRBs=15. The CRS muting region can be the middle 20 PRBs since they are included in all three rate matching patterns.

Second Example with 15 MHz LTE Bandwidth: A second example for a 15 MHz bandwidth is described below. In LTE, 15 MHz bandwidth may include 75 useable PRBs. In this example, the set of maximum number of muted PRB values that are supported are: 75 PRBs, 50 PRBs, 35 PRBs, and 25 PRBs. Note, however, that these values are only examples.

In the second example, with a maximum number of muted PRBs=75, there is only one rate matching pattern set with one pattern: the true center frequency with a bandwidth of 6 PRBs. The CRS muting forbidden region can be the middle 6 PRBs.

In the second example, with a maximum number of muted PRBs=50, there are three one rate matching pattern sets:
Set 1:
   Pattern 1: the true center frequency with a bandwidth of 15 PRBs. The CRS muting forbidden region can be the middle 15 PRBs.
Set 2:
   Pattern 1: the true center frequency with a bandwidth of 25 PRBs. The CRS muting forbidden region can be the middle 25 PRBs.
Set 3:
   Pattern 1: the true center frequency with a bandwidth of 15 PRBs.
   Pattern 2: the true center frequency with a bandwidth of 25 PRBs.
   The CRS muting forbidden region can be the middle 15 PRBs.

In the second example, with a maximum number of muted PRBs=35, there are four rate matching pattern sets:
Set 1:
   Pattern 1: the true center frequency with a bandwidth of 25 PRBs.
   The CRS muting forbidden region can be the middle 25 PRBs.
Set 2:
   Pattern 1: the true center frequency with a bandwidth of 50 PRBs.
   The CRS muting forbidden region can be the middle 50 PRBs.
Set 3:
   Pattern 1: the true center frequency with a bandwidth of 25 PRBs.
   Pattern 2: the true center frequency with a bandwidth of 50 PRBs.
   The CRS muting forbidden region can be the middle 25 PRBs.
Set 4:
   Pattern 1: the true center frequency with a bandwidth of 25 PRBs.
   Pattern 2: a bandwidth of 50 PRBs, a center frequency shifted upwards by about 20 PRBs.
   Pattern 3: a bandwidth of 50 PRBs, a center frequency shifted downwards by about 20 PRB.

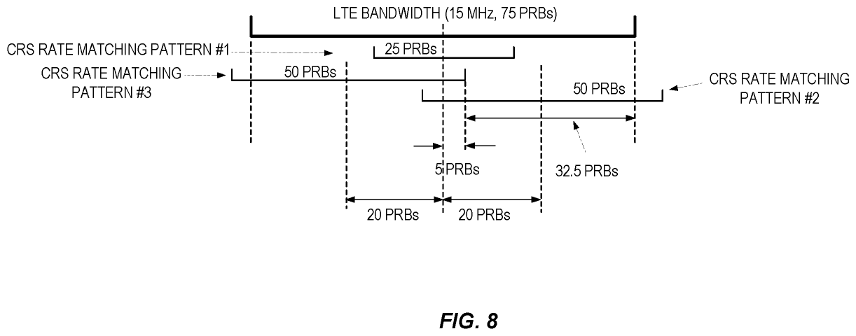

FIG. 8 illustrates the above three patterns in Set 4. The CRS muting forbidden region can be the central 10 PRBs.

In the second example, with a maximum number of muted PRBs=25, there are two rate matching pattern sets:
Set 1:
   Pattern 1: the true center frequency with a bandwidth of 25 PRBs.
   Pattern 2: a bandwidth of 50 PRBs, a center frequency shifted upwards by about 10 PRBs.
   Pattern 3: a bandwidth of 50 PRBs, a center frequency shifted downwards by about 10 PRBs.
   The CRS muting forbidden region can be the central 25 PRBs.
Set 2:
   Pattern 1: the true center frequency with a bandwidth of 50 PRBs.
   2: a bandwidth of 50 PRBs, a center frequency shifted upwards by about 10 PRBs.
   Pattern 3: a bandwidth of 50 PRBs, a center frequency shifted downwards by about 10 PRBs.
   The CRS muting forbidden region can be the central 25 PRBs.

Third Example with 20 MHz LTE Bandwidth: A third example for 20 MHz LTE bandwidth is described below. In LTE, a 20 MHz bandwidth may include 100 useable PRBs. In this example, the allowed maximum number of muted PRBs is 100 PRBs, 75 PRBs, 50 PRBs, and 25 PRBs. Note, however, that these values are only examples.

In the third example, with a maximum number of muted PRBs=100, there is only one rate matching pattern set with one pattern: the true center frequency with a bandwidth of 6 PRBs. The CRS muting forbidden region can be the central 6 PRBs.

In the third example, with a maximum number of muted PRBs=75, there are three one rate matching pattern sets:
Set 1:
   Pattern 1: the true center frequency with a bandwidth of 15 PRBs.
   The CRS muting forbidden region can be the central 14 or 16 PRBs.
Set 2:
   Pattern 1: the true center frequency with a bandwidth of 25 PRBs.
   The CRS muting forbidden region can be the central 24 or 26 PRBs.
Set 3:
   Pattern 1: the true center frequency with a bandwidth of 15 PRBs.
   Pattern 2: the true center frequency with a bandwidth of 25 PRBs.
   The CRS muting forbidden region can be the central 14 or 16 PRBs.

In the third example, with a maximum number of muted PRBs=50, there are four rate matching pattern sets:
Set 1:
   Pattern 1: the true center frequency with a bandwidth of 25 PRBs.
   The CRS muting forbidden region can be the central 24 or 26 PRBs.
Set 2:
   Pattern 1: the true center frequency with a bandwidth of 50 PRBs.
   The CRS muting forbidden region can be the central 50 PRBs.
Set 3:
   Pattern 1: the true center frequency with a bandwidth of 25 PRBs.
   Pattern 2: the true center frequency with a bandwidth of 50 PRBs.
   The CRS muting forbidden region can be the central 24 or 26 PRBs.
Set 4:
   Pattern 1: the true center frequency with a bandwidth of 50 PRBs.
   Pattern 2: a bandwidth of 50 PRBs, a center frequency shifted upwards by about 20 PRBs.
   Pattern 3: a bandwidth of 50 PRBs, a center frequency shifted downwards by about 20 PRBs.
   The CRS muting forbidden region can be the central 10 PRBs.

In the third example, with a maximum number of muted PRBs=25, there are two rate matching pattern sets:
Set 1:
   Pattern 1: the true center frequency with a bandwidth of 50 PRBs.
   Pattern 2: a bandwidth of 75 PRBs, a center frequency shifted upwards by about 10 PRBs.
   Pattern 3: a bandwidth of 75 PRBs, a center frequency shifted downwards by about 10 PRBs.
   The CRS muting forbidden region can be the central 10 PRBs.
Set 2:
   Pattern 1: the true center frequency with a bandwidth of 75 PRBs.
   Pattern 2: a bandwidth of 75 PRBs, a center frequency shifted upwards by about 10 PRBs.
   Pattern 3: a bandwidth of 75 PRBs, a center frequency shifted downwards by about 10 PRBs.
   The CRS muting forbidden region can be the central 10 PRBs.

When there are multiple rate matching pattern sets for a given maximum number of muted PRBs, one pattern set can be selected or configured based on NR performance. When a rate matching pattern set contains multiple patterns, each pattern can be assigned (e.g., pre-configured) a weight. The weight is used when selecting a pattern for a given UE. If some pattern is more favorable, a higher weight can be assigned to the pattern. With equal weight, the selection is random.

### Resource Arbitration

For DL resource arbitration, the NR resources (i.e., the “NR region” of the frequency spectrum) can start from either the bottom of the bandwidth (lowest frequency in the shared spectrum) or top of the bandwidth (highest frequency in the shared spectrum). When NR Control Resource Set (CORESET) 0 (i.e., “CORESET0”) is involved, it should be taken into account when determining the NR region starting point.

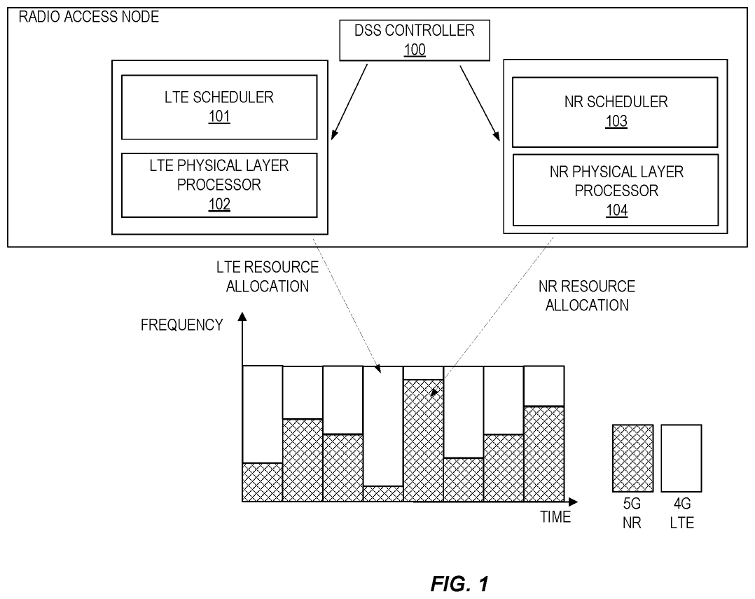

The DSS controller 100 (of the radio access node 202 as shown in FIG. 1) should be informed about the selected CRS muting pattern set, the maximum number of muted PRBs, and the muting period. In each subframe, the DSS controller 100 decides how to split PRBs between NR and LTE. In one embodiment, the starting point of the NR region should alternate between bandwidth top and bottom if CORESET0 is not involved.

For each PRB, the DSS controller 100 keeps a record about the last subframe in which CRS on the PRB is muted. In each subframe, the DSS controller 100 identifies the eligible muting PRBs as the PRBs for which the duration from the last muted time to current subframe is not less than the muting period. It then identifies the intersection of the eligible muting PRBs and the PRBs assigned to NR. If the intersection is not greater than the maximum number of muted PRBs, CRS over all PRBs in the intersection can be muted.

Otherwise, the number of PRBs over which CRS can be muted is limited to the maximum number of muted PRBs. There are many ways to select the maximum number of PRBs. One option is to select PRBs based on NR region starting point. If NR region starts from the lower end of the spectrum, the PRBs with the lowest frequency in the intersection are selected. If NR region starts from the higher end of the spectrum, the PRBs with the highest frequency in the intersection are selected. The second option is to always select PRBs with the lowest frequency. The third option is to select PRBs with the longest duration (from the last muted time to current subframe). LTE CRS on PRBs in the CRS muting forbidden region should not be muted. The location of those PRBs is sent to both NR and LTE sides. LTE will mute CRS on those PRBs. NR uses the info to perform PDSCH scheduling and link adaptation. For those PRBs, the DSS controller 100 will update the last subframe when CRS is muted.

### NR PDSCH Link Adaptation

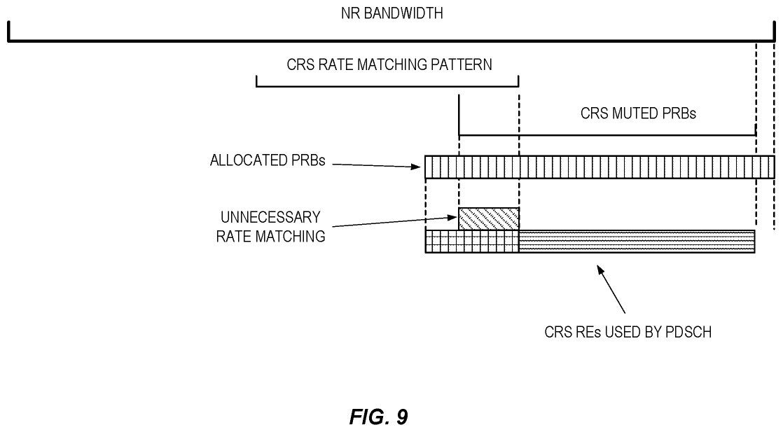

Special handling is needed for NR PDSCH link adaptation. FIG. 9 illustrates an example of NR PDSCH link adaptation. In FIG. 9, there is no gap between the configured LTE CRS rate matching pattern and the muting section within the allocated PRBs. An NR UE is allocated with a certain number of PRBs in a subframe. The LTE CRS rate matching pattern configured for the UE and the CRS muted PRBs in the subframe are also shown in FIG. 9. For allocated PRBs overlapping with the LTE CRS rate matching pattern, the UE performs CRS rate matching. For allocated PRBs that are outside of rate matching pattern and overlap with CRS muted PRBs, UE does not do CRS rate matching and benefits from lower overhead. When doing PDSCH link adaptation, the NR scheduler 103 needs to know CRS rate matching may not be done over all allocated PRBs. For allocated PRBs that overlap with both LTE CRS rate matching pattern and CRS muted PRBs, the UE still performs rate matching even though it is not necessary. This UE does not get the benefit of CRS muting. However, UEs in the neighbor cells may benefit from no LTE CRS interference from the UE in those RBs.

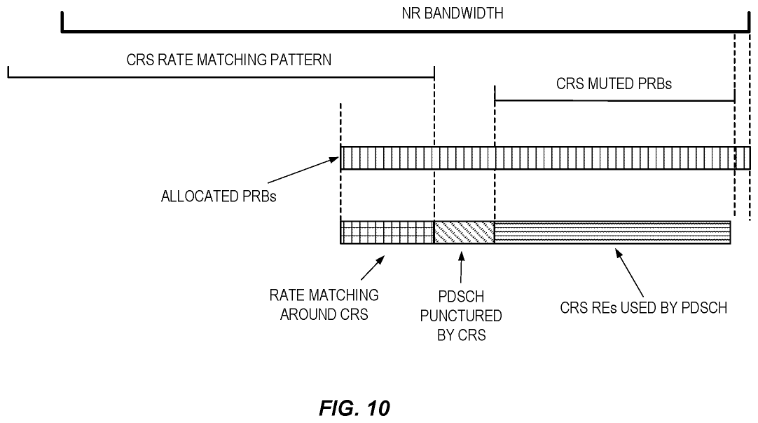

In FIG. 10, NR PDSCH needs to be punctured by LTE CRS on some PRBs. This happens for the PRBs that are not included in either CRS rate matching pattern or the CRS muted PRBs. In FIG. 10, there is a gap between the configured rate matching pattern and the muting section within the allocated PRBs.

Comparing to CRS rate matching, PDSCH puncturing leads to worse performance. When CRS rate matching pattern has smaller bandwidth and the maximum number of muted PRBs is smaller, PDSCH puncturing may happen on more PRBs.

PDSCH puncturing cannot be avoided. For example, there are subframes in which full bandwidth CRS needs to be transmitted. When no CRS rate matching pattern covers the full bandwidth, PDSCH puncturing can occur on PRBs that are not included in the configured CRS rate matching pattern. When NR PDSCH Resource Elements (REs) in some PRBs are punctured by LTE CRS, its impact should be considered by link adaptation.
When counting the number of REs available for NR PDSCH, the CRS REs should not be included.
A Signal to Interference and Noise Ratio (SINR) offset can be applied when determining the PDSCH modulation and coding scheme. The offset may depend on the ratio of the number of punctured REs to the number of REs that can be used for NR PDSCH without CRS puncturing.
If the selected MCS is still aggressive, the estimated SINR will be corrected by outer loop.

### NR (DL) Scheduler

The NR (DL) scheduler 104 is illustrated in FIG. 1. If PDSCH scheduling is not frequency selective, the NR scheduler 103 can select any PRBs for a given UE. In this case, PRBs can be selected in the following priority order. First, PRBs that are outside of the CRS rate matching pattern and over which CRS is muted. The UE can take advantage of CRS muting. Second, PRBs that are included in the CRS rate matching pattern and over which CRS is not muted. Normal rate matching is performed. Third, PRBs included in the CRS rate matching pattern and over which CRS is muted. The UE cannot take advantage of CRS muting. The performance is not impacted. Fourth, PRBs that are outside of the CRS rate matching pattern and over which CRS is not muted. PDSCH is punctured by LTE CRS and performance is impacted. The method described above does not depend on the location of the PDSCH starting symbol.

### Further Description

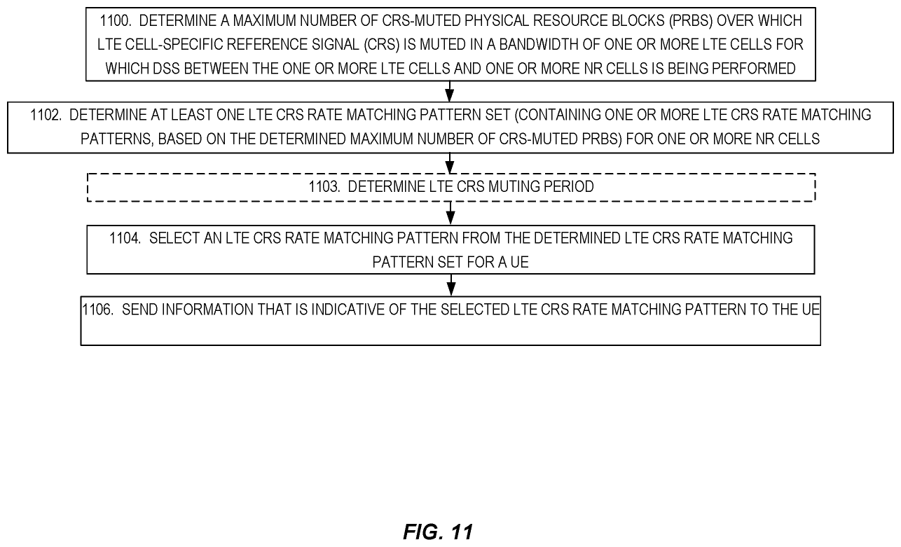

FIG. 11 is a flow chart that illustrates the operation of a network node in accordance with an exemplary embodiment of the present disclosure. In the following description of FIG. 11, the network node performing the process is the radio access node 202 that performs the DSS; however, the present disclosure is not limited thereto. Some or all of the steps of the process of FIG. 11 may alternatively be performed by another network node. The procedure of FIG. 11 includes various aspects related to the description above. As such, the description above is applicable to the procedure of FIG. 11 as the details above pertain to the steps of the procedure of FIG. 11.

In step 1100, the radio access node 202 for a DSS system serving at least two Radio Access Technologies (i.e., LTE and NR in the example embodiments described herein) determines a maximum number of CRS-muted PRBs over which an LTE CRS is muted in a bandwidth of one or more LTE cells for which DSS between the one or more LTE cells and one or more NR cells is being performed. This determination may be made based on, e.g., a configuration of the value of the maximum number of CRS-muted PRBs received from, e.g., an operator of the network. One option is to pre-define a set of allowed values for a given bandwidth and an operator can select one value from the set. Alternatively, the maximum number of CRS-muted PRBs may correspond to any number of PRBs not greater than the bandwidth of one or more LTE cells for which DSS is being performed.

In step 1102, the radio access node 202 determines, based on the determined maximum number of CRS-muted PRBs, an LTE CRS rate matching pattern set for the one or more NR cells. The LTE CRS rate matching pattern set contains one or more LTE CRS rate matching patterns. More specifically, in one example embodiment, there are one or multiple LTE CRS rate matching pattern sets for a given bandwidth and selected maximum number of CRS-muted PRBs. If there are multiple LTE CRS rate matching pattern sets, an operator can select one set based on NR deployment, NR UE/traffic penetration, and other factors. Optionally, the LTE CRS rate matching pattern set comprises two LTE CRS rate matching patterns having (a) a common LTE downlink center frequency and (b) two different bandwidths.

In optional step 1103, the RAN node 202 determines an LTE CRS muting period.

In step 1104, the radio access node 202 selects an LTE CRS rate matching pattern from the determined LTE CRS rate matching pattern set for a UE 1600. Each pattern can be assigned with a relative weight. A higher weight means the pattern is more likely to be selected. When all patterns have the same weight, the selection is random. The optimal weights can be derived from simulations or test results from lab or field.

In step 1106, the radio access node 202 performs a signaling to the UE(s), such as sending information that is indicative of the selected LTE CRS rate matching pattern to the UE(s). The UE(s) may then operate in accordance with the selected LTE CRS rate matching pattern.

Optionally, the radio access node 202 may set, determine, or obtain a CRS muting forbidden region as (a) 6 PRBs in the middle of the bandwidth or (b) a number of PRBs in the middle of the bandwidth, which depend on the determined maximum number of CRS-muted PRBs and the determined LTE CRS rate matching pattern set.

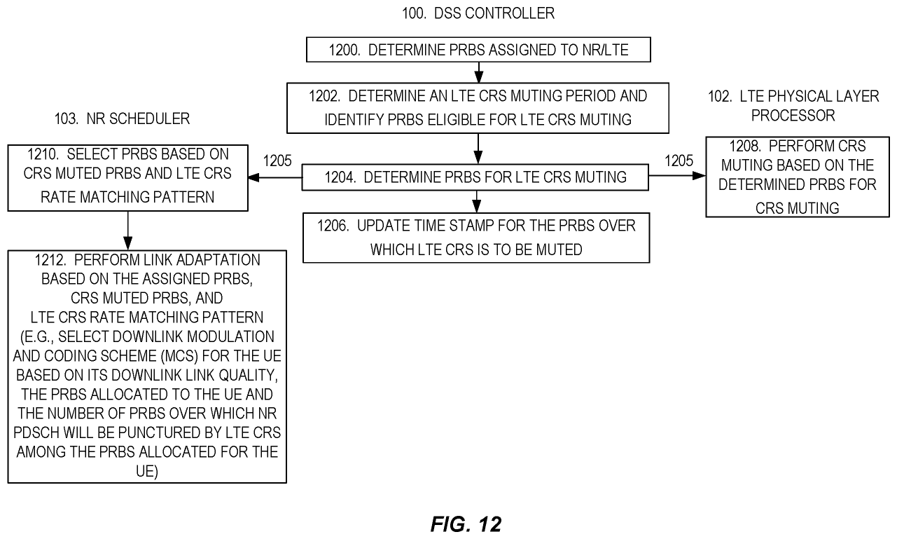

FIG. 12 is a flow chart of an exemplary embodiment of the DSS controller 100 interacting with the LTE physical layer processor 102 and the NR scheduler 103 in the present disclosure.

In step 1200, the DSS controller 100 determines PRBs assigned to LTE and NR. In step 1202, the DSS controller 100 determines an LTE CRS muting period and identifies PRBs that are eligible for LTE CRS muting. In step 1204, the DSS controller 100 determines PRBs for LTE CRS muting as up to the determined maximum number of CRS-muted PRBs from an intersection of eligible PRBs and PRBs assigned to NR. For example, for each PRB, the DSS controller 100 keeps a record about the last subframe in which CRS on the PRB is muted. In each subframe, the DSS controller 100 identifies the eligible muting PRBs as the PRBs for which the duration from the last muted time to current subframe is not less than the muting period. It then identifies the intersection of the eligible muting PRBs and the PRBs assigned to NR. If the intersection is not greater than the maximum number of muted PRBs, CRS over all PRBs in the intersection can be muted. Otherwise, the number of PRBs for LTE CRS muting is limited to the maximum number of muted PRBs.

In step 1205, the DSS controller 100 sends information that is indicative of the PRBs for LTE CRS muting to the LTE physical layer processor 102 and to the NR scheduler 103. In step 1206, the DSS controller 100 updates a time stamp for the PRBs over which LTE CRS is to be muted.

In step 1208, the LTE physical layer processor 102 performs CRS muting based on the determined PRBs for CRS muting. In step 1210, when the NR scheduler 103 schedules data transmission for a UE, it selects PRBs based on the CRS-muted PRBs and the LTE CRS rate matching pattern configured for the given UE. In step 1212, the NR scheduler 103 performs link adaptation based on the PRBs allocated to the given UE, the CRS-muted PRBs, and the LTE CRS rate matching pattern configured for the UE. For example, the NR scheduler 103 selects downlink modulation and coding scheme (MCS) for the UE based on its downlink link quality, the PRBs allocated to the UE and the number of PRBs over which NR PDSCH will be punctured by LTE CRS among the PRBs allocated for the UE.

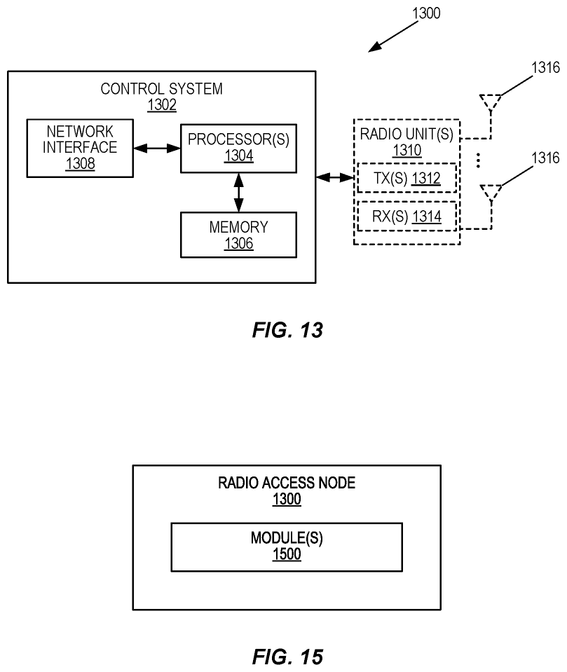

FIG. 13 is a schematic block diagram of the radio access node 1300 according to some embodiments of the present disclosure. Optional features are represented by dashed boxes. The radio access node 1300 may be, for example, a base station 202 or 206 or a network node that implements all or part of the functionality of the base station 202 or gNB described herein. As illustrated, the radio access node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. In addition, the radio access node 1300 may include one or more radio units 1310 that each includes one or more transmitters 1312 and one or more receivers 1314 coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of a radio access node 1300 as described herein. In some embodiments, the function(s) are implemented in software that is stored, e.g., in the memory 1306 and executed by the one or more processors 1304.

FIG. 14 is a schematic block diagram that illustrates a virtualized embodiment of the radio access node 1300 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1300 in which at least a portion of the functionality of the radio access node 1300 is implemented as a virtual component(s) (e.g., via a virtual machine(s) executing on a physical processing node(s) in a network(s)). As illustrated, in this example, the radio access node 1300 may include the control system 1302 and/or the one or more radio units 1310, as described above. The control system 1302 may be connected to the radio unit(s) 1310 via, for example, an optical cable or the like. The radio access node 1300 includes one or more processing nodes 1400 coupled to or included as part of a network(s) 1402. If present, the control system 1302 or the radio unit(s) are connected to the processing node(s) 1400 via the network 1402. Each processing node 1400 includes one or more processors 1404 (e.g., CPUs, ASICs, FPGAs, and/or the like), memory 1406, and a network interface 1408.

In this example, functions 1410 of the radio access node 1300 described herein are implemented at the one or more processing nodes 1400 or distributed across the one or more processing nodes 1400 and the control system 1302 and/or the radio unit(s) 1310 in any desired manner. In some particular embodiments, some or all of the functions 1410 of the radio access node 1300 described herein are implemented as virtual components executed by one or more virtual machines implemented in a virtual environment(s) hosted by the processing node(s) 1400. As will be appreciated by one of ordinary skill in the art, additional signaling or communication between the processing node(s) 1400 and the control system 1302 is used in order to carry out at least some of the desired functions 1410. Notably, in some embodiments, the control system 1302 may not be included, in which case the radio unit(s) 1310 communicate directly with the processing node(s) 1400 via an appropriate network interface(s).

In some embodiments, a computer program including instructions which, when executed by at least one processor, causes the at least one processor to carry out the functionality of radio access node 1300 or a node (e.g., a processing node 1400) implementing one or more of the functions 1410 of the radio access node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

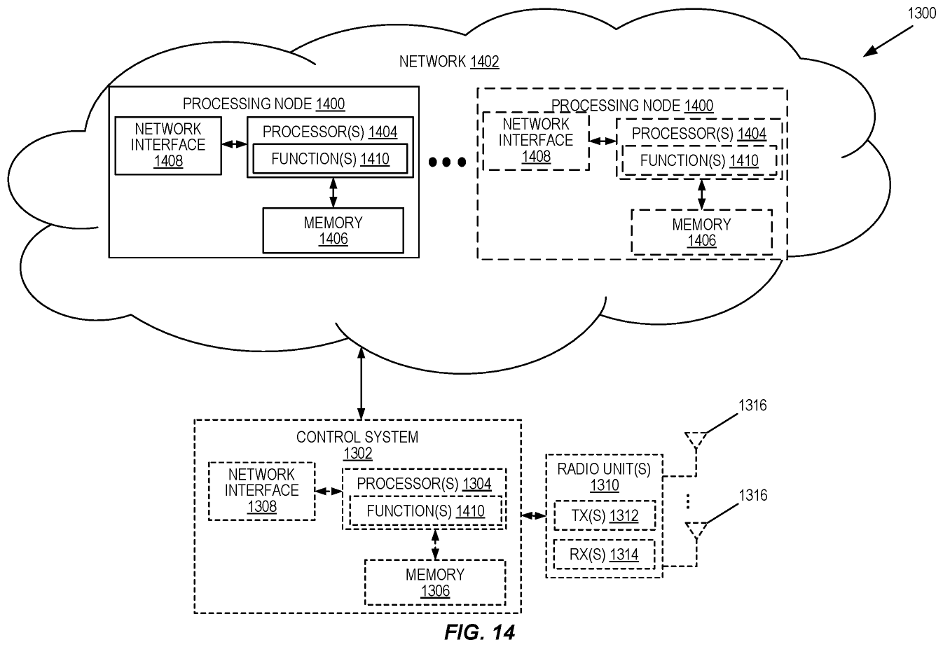

FIG. 15 is a schematic block diagram of the radio access node 1300 according to some other embodiments of the present disclosure. The radio access node 1300 includes one or more modules 1500, each of which is implemented in software. The module(s) 1500 provide the functionality of the radio access node 1300 described herein. This discussion is equally applicable to the processing node 1400 of FIG. 14 where the modules 1500 may be implemented at one of the processing nodes 1400 or distributed across multiple processing nodes 1400 and/or distributed across the processing node(s) 1400 and the control system 1302.

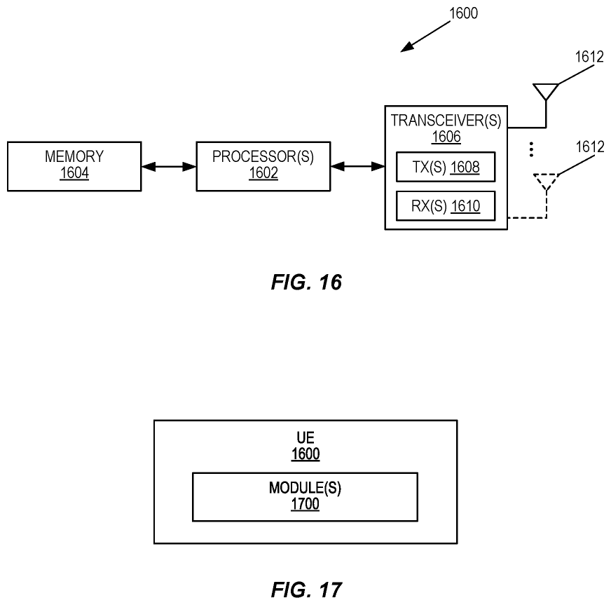

FIG. 16 is a schematic block diagram of a wireless communication device 1600 according to some embodiments of the present disclosure. As illustrated, the wireless communication device 1600 includes one or more processors 1602 (e.g., CPUs, ASICs, FPGAS, and/or the like), memory 1604, and one or more transceivers 1606 each including one or more transmitters 1608 and one or more receivers 1610 coupled to one or more antennas 1612. The transceiver(s) 1606 includes radio-front end circuitry connected to the antenna(s) 1612 that is configured to condition signals communicated between the antenna(s) 1612 and the processor(s) 1602, as will be appreciated by on of ordinary skill in the art. The processors 1602 are also referred to herein as processing circuitry. The transceivers 1606 are also referred to herein as radio circuitry. In some embodiments, the functionality of the wireless communication device 1600 described above may be fully or partially implemented in software that is, e.g., stored in the memory 1604 and executed by the processor(s) 1602. Note that the wireless communication device 1600 may include additional components not illustrated in FIG. 16 such as, e.g., one or more user interface components (e.g., an input/output interface including a display, buttons, a touch screen, a microphone, a speaker(s), and/or the like and/or any other components for allowing input of information into the wireless communication device 1600 and/or allowing output of information from the wireless communication device 1600), a power supply (e.g., a battery and associated power circuitry), etc.

In some embodiments, a computer program including instructions which, when executed by at least one processor, causes the at least one processor to carry out the functionality of the wireless communication device 1600 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 17 is a schematic block diagram of the wireless communication device 1600 according to some other embodiments of the present disclosure. The wireless communication device 1600 includes one or more modules 1700, each of which is implemented in software. The module(s) 1700 provide the functionality of the wireless communication device 1600 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core |
| 5GS | Fifth Generation System |
| AF | Application Function |
| AMF | Access and Mobility Function |
| AN | Access Network |
| AP | Access Point |
| ASIC | Application Specific Integrated Circuit |
| AUSF | Authentication Server Function |
| CPU | Central Processing Unit |
| CRS | Cell-specific Reference Signal |
| DCI | Downlink Control Information |
| DL | Downlink |
| DN | Data Network |
| DSP | Digital Signal Processor |
| DSS | Dynamic Spectrum Sharing |
| eNB | Enhanced or Evolved Node B |
| EPC | Evolved Packet Core |
| EPS | Evolved Packet System |
| E-UTRA | Evolved Universal Terrestrial Radio Access |
| FPGA | Field Programmable Gate Array |
| gNB | New Radio Base Station |
| gNB-DU | New Radio Base Station Distributed Unit |
| HSS | Home Subscriber Server |
| IoT | Internet of Things |
| IP | Internet Protocol |
| LTE | Long Term Evolution |
| MAC | Medium Access Control |
| MCS | Modulation and Coding Scheme |
| MME | Mobility Management Entity |
| MTC | Machine Type Communication |
| NEF | Network Exposure Function |
| NF | Network Function |
| NR | New Radio |
| NRF | Network Function Repository Function |
| NSSF | Network Slice Selection Function |
| PC | Personal Computer |
| PCF | Policy Control Function |
| PDSCH | Physical Downlink Shared Channel |
| P-GW | Packet Data Network Gateway |
| PRB | Physical Resource Block |
| PRS | Positioning Reference Signal |
| QoS | Quality of Service |
| RAM | Random Access Memory |
| RAN | Radio Access Network |
| RAT | Radio Access Technology |
| RE | resource element |
| ROM | Read Only Memory |
| RRC | Radio Resource Control |
| RP | Reception Point |
| RRH | Remote Radio Head |
| RTT | Round Trip Time |
| SCEF | Service Capability Exposure Function |
| SINR | Signal to Interference and Noise Ratio |
| SMF | Session Management Function |
| TCI | Transmission Configuration Indicator |
| TP | Transmission Point |
| TRP | Transmission/Reception Point |
| UDM | Unified Data Management |
| UE | User Equipment |
| UPF | User Plane Function |

Those skilled in the art will recognize improvements and modifications to the embodiments of the present disclosure. All such improvements and modifications are considered within the scope of the concepts disclosed herein.

1. A method performed by a radio access node for a Dynamic Spectrum Sharing, DSS, system serving at least two Radio Access Technologies, Long Term Evolution, LTE, and New Radio, NR, the method comprising:
determining a maximum number of CRS-muted Physical Resource Blocks, PRBs, over which an LTE Cell-specific Reference Signal, CRS, is muted in a bandwidth of one or more LTE cells for which DSS between the one or more LTE cells and one or more NR cells is being performed;
determining, based on the determined maximum number of CRS-muted PRBs, an LTE CRS rate matching pattern set for the one or more NR cells, the LTE CRS rate matching pattern set containing one or more LTE CRS rate matching patterns;
selecting an LTE CRS rate matching pattern from the determined LTE CRS rate matching pattern set for a User Equipment, UE; and
sending information that is indicative of the selected LTE CRS rate matching pattern to the UE.

2. The method of claim 1, further comprising setting a CRS muting forbidden region as (a) 6 PRBs in the middle of the bandwidth or (b) a number of PRBs in the middle of the bandwidth, which depend on the determined maximum number of CRS-muted PRBs and the determined LTE CRS rate matching pattern set.

3. The method of claim 1, wherein the maximum number of CRS-muted PRBs corresponds to any number of PRBs not greater than the bandwidth of the LTE cell for which DSS is being performed, or a limited number of values that are not greater than the LTE bandwidth.

4. The method of claim 1, wherein the LTE CRS rate matching pattern set comprises two LTE CRS rate matching patterns having (a) a common LTE downlink center frequency and (b) two different bandwidths.

5. The method of claim 1, wherein:
the LTE CRS rate matching pattern set comprises:
(i) a first LTE CRS rate matching pattern having (a) a first LTE downlink center frequency and (b) a first bandwidth,
(ii) a second LTE CRS rate matching pattern having (a) a second LTE downlink center frequency that is lower than the first LTE downlink center frequency and (b) a second bandwidth, which is the same as or different from the first bandwidth, and
(iii) a third LTE CRS rate matching pattern having (a) a third LTE downlink center frequency that is higher than the first LTE downlink center frequency and (b) a third bandwidth, which is equal to the second bandwidth.

6. The method of claim 1, wherein the LTE CRS rate matching patterns comprises (a) a first LTE CRS rate matching pattern having a center frequency shifted upwards from a true center frequency of the bandwidth of one or more LTE cells for which DSS is being performed and (b) a second LTE CRS rate matching pattern having a center frequency shifted downwards from the true center frequency of the bandwidth of the one or more LTE cells for which DSS is being performed.

7. The method of claim 1, wherein the radio access node comprises a DSS controller, an LTE scheduler, an LTE physical layer processor, a NR scheduler, and a NR physical layer processor.

8. The method of claim 7, wherein the DSS controller:
determines PRBs assigned to LTE and NR;
determines an LTE CRS muting period and identifies PRBs that are eligible for LTE CRS muting;
determines PRBs for LTE CRS muting as up to the determined maximum number of CRS-muted PRBs from an intersection of eligible PRBs and PRBs assigned to NR;
sends, to the LTE physical layer processor and to the NR scheduler, information that is indicative of the PRBs for LTE CRS muting; and
updates a time stamp for the PRBs over which LTE CRS is to be muted.

9. The method of claim 8, wherein the LTE physical layer processor performs CRS muting based on the determined PRBs for CRS muting.

10. The method of claim 8, wherein the NR scheduler selects PRBs for a UE based on the CRS-muted PRBs and the LTE CRS rate matching pattern configured for the UE.

11. The method of claim 7, wherein the NR scheduler selects downlink Modulation and Coding Scheme, MCS, for the UE based on its downlink link quality, the PRBs allocated to the UE and the number of PRBs over which NR PDSCH will be punctured by LTE CRS among the PRBs allocated for the UE.

12. A radio access node for a Dynamic Spectrum Sharing, DSS,
system serving at least two Radio Access Technologies, Long Term Evolution, LTE, and New Radio, NR, the radio access node adapted to:
determine a maximum number of CRS-muted Physical Resource Blocks, PRBs, over which an LTE Cell-specific Reference Signal, CRS, is muted in a bandwidth of one or more LTE cells for which DSS between the one or more LTE cells and one or more NR cells is being performed;
determine, based on the determined maximum number of CRS-muted PRBs, an LTE CRS rate matching pattern set for the one or more NR cells, the LTE CRS rate matching pattern set containing one or more LTE CRS rate matching patterns;
select an LTE CRS rate matching pattern from the determined LTE CRS rate matching pattern set for a User Equipment, UE; and
send information that is indicative of the selected LTE CRS rate matching pattern to the UE.

13-15. (canceled)

16. The method of claim 1, further comprising setting a CRS muting forbidden region as 6 PRBs in the middle of the bandwidth.

17. The method of claim 1, further comprising setting a CRS muting forbidden region as a number of PRBs in the middle of the bandwidth, which depend on the determined maximum number of CRS-muted PRBs and the determined LTE CRS rate matching pattern set.

18. The method of claim 1, wherein the maximum number of CRS-muted PRBs corresponds to any number of PRBs not greater than the bandwidth of the LTE cell for which DSS is being performed.

19. The method of claim 1, wherein the maximum number of CRS-muted PRBs corresponds to a limited number of values that are not greater than the bandwidth of the LTE cell for which DSS is being performed.

20. The method of claim 1, wherein:
the LTE CRS rate matching pattern set comprises:
(i) a first LTE CRS rate matching pattern having (a) a first LTE downlink center frequency and (b) a first bandwidth,
(ii) a second LTE CRS rate matching pattern having (a) a second LTE downlink center frequency that is lower than the first LTE downlink center frequency and (b) a second bandwidth, which is the same as the first bandwidth, and
(iii) a third LTE CRS rate matching pattern having (a) a third LTE downlink center frequency that is higher than the first LTE downlink center frequency and (b) a third bandwidth, which is equal to the second bandwidth.

21. The method of claim 1, wherein:
the LTE CRS rate matching pattern set comprises:
(i) a first LTE CRS rate matching pattern having (a) a first LTE downlink center frequency and (b) a first bandwidth,
(ii) a second LTE CRS rate matching pattern having (a) a second LTE downlink center frequency that is lower than the first LTE downlink center frequency and (b) a second bandwidth, which is different from the first bandwidth, and
(iii) a third LTE CRS rate matching pattern having (a) a third LTE downlink center frequency that is higher than the first LTE downlink center frequency and (b) a third bandwidth, which is equal to the second bandwidth.
